(19) United States
(12) Patent Application Publication
(10) Pub. No.: US 2012/0076161 A1
(43) Pub. Date: Mar. 29, 2012

(54) LONG DISTANCE TRANSMISSION USING MULTI-MODE VCSEL UNDER INJECTION LOCKING

(75) Inventors: Connie Chang-Hasnain, Palo Alto, CA (US); Devang Parekh, Union City, CA (US); Xiaoxue Zhao, Fremont, CA (US); Peng Guo, Beijing (CN); Weijian Yang, Berkeley, CA (US)

(73) Assignee: THE REGENTS OF THE UNIVERSITY OF CALIFORNIA, Oakland, CA (US)

(21) Appl. No.: 13/234,080

(22) Filed: Sep. 15, 2011

Related U.S. Application Data
(63) Continuation of application No. PCT/US2010/027528, filed on Mar. 16, 2010.
(60) Provisional application No. 61/160,366, filed on Mar. 16, 2009.

(51) Int. Cl. H01S 3/13

(52) U.S. Cl. 372/29.02

(57) ABSTRACT

Adjustable chirp is achieved in injection-locked, 10-Gb/s directly modulated, multimode 1.55-μm VCSELs for the first time, leading to 90× increase in standard single-mode fiber transmission distance to 90 km.

### CROSS-REFERENCE TO RELATED APPLICATIONS

This application a 35 U.S.C. §111(a) continuation of PCT international application number PCT/US2010/027528 filed on Mar. 16, 2010, incorporated herein by reference in its entirety, which is a nonprovisional of U.S. provisional patent application Ser. No. 61/160,366 filed on Mar. 16, 2009, incorporated herein by reference in its entirety. Priority is claimed to each of the foregoing applications.

The above-referenced PCT international application was published as PCT International Publication No. WO 2010/107828 on Sep. 23, 2010 and republished on Jan. 13, 2011, and is incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention pertains generally to long distance transmission using multi-mode (MM) vertical cavity surface emitting lasers (VCSELs) under injection locking, and more particularly to 90-km single-mode fiber transmission of 10-Gb/s multimode VCSELs under optical injection locking.

2. Description of Related Art

Multimode vertical-cavity surface-emitting lasers (MM VCSELs) are extensively used for short reach communications due to their low cost of manufacture and high data rate capabilities. However, for MM VCSELs to be a candidate for WDM applications in a metro-area network, their spectra must be narrowed and frequency chirp reduced to facilitate longer distance transmission over standard single-mode fiber (SSMF) while still maintaining a broad modulation bandwidth.

Optical injection locking (OIL) has been shown to be effective in enhancing small-signal modulation bandwidth of single-mode (SM) VCSELs. Similar behavior and underlying physics are observed in OIL MM VCSELs, with enhanced small-signal modulation bandwidth to 54 GHz and suppression of the higher-order modes of MM VCSELs. Furthermore, OIL can provide adjustable chirp in SM VCSELs, leading to dispersion compensation and an increase of SSMF transmission by a factor of 10 km to 140 km. However, this particular aspect has not been studied on MM VCSELs. OIL MM-VCSELs can be extremely promising for low-cost metro networks if similar adjustable dispersion compensation can be obtained and SSMF transmission can be demonstrated.

### BRIEF SUMMARY OF THE INVENTION

Quite surprisingly we have found that an OIL MM VCSEL can act like a SM VCSEL, and transmits over much longer distance with adjustable frequency chirp due to injection locking. We illustrate that chirp reduction can be adjusted by changing the injection ratio of the master laser with respect to the VCSEL. Measurement of time-resolved chirp waveforms verifies this chirp tunability. Finally, we show that 10-Gb/s OIL 10 μm and 15 μm aperture MM VCSELs transmit over 90 km and 32 km respectively over standard single-mode fiber (SSMF) with negligible power penalty at 10⁻⁹ bit-error-rate (BER). This result shows a 90× and 16× greater dispersion tolerance for OIL 10 μm and 15 μm MM VCSELs compared to that of a free-running directly-modulated MM VCSEL.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a block diagram of an optical injection locking (OIL) multi-mode (MM) vertical cavity surface emitting laser (VCSEL) with tunable chirp for dispersion compensation according to the present invention, shown in the context of an experimental setup that was used to evaluate functionality.

FIG. 2 shows time-resolved frequency chirp and signal intensity waveforms at 10-Gb/s for a free-running 15-μm MM VCSEL and I=25 mA.

FIG. 3 shows time-resolved frequency chirp and signal intensity waveforms at 10-Gb/s for an OIL 15-μm MM VCSEL with a 3 dB injection ratio and I=12.2 mA.

FIG. 4 shows time-resolved frequency chirp and signal intensity waveforms at 10-Gb/s for an OIL 15-μm MM VCSEL with a 6 dB injection ratio and I=12.2 mA.

FIG. 5 shows time-resolved frequency chirp and signal intensity waveforms at 10-Gb/s for a free-running 10-μm MM VCSEL and I=24 mA.

FIG. 6 shows time-resolved frequency chirp and signal intensity waveforms at 10-Gb/s for an OIL 10-μm MM VCSEL with a 3 dB injection ratio and I=10.0 mA.

FIG. 7 shows time-resolved frequency chirp and signal intensity waveforms at 10-Gb/s for an OIL 10-μm MM VCSEL with a 6 dB injection ratio and I=10.0 mA.

FIG. 8 shows extinction ratio and transient chirp vs. injection ratio for OIL MM VCSELs modulated at 10 Gb/s, with free-running extinction ratios and transient chirps at high bias shown for comparison.

FIG. 9 shows optical spectra for 10 Gb/s modulated OIL and free-running 15 μm MM VCSEL.

FIG. 10 shows power penalty vs. SSMF transmission distance for free-running 15 μm aperture MM VCSEL and OIL MM VCSEL with 3 dB and 6 dB injection ratio at 10 Gb/s.

FIG. 11 shows power penalty vs. SSMF transmission distance for free-running 10-μm aperture MM VCSEL and OIL MM VCSEL with 6 dB injection ratio at 10 Gb/s.

FIG. 12 schematically shows an OIL-VCSEL model with the interference effect according to an embodiment of the invention.

FIG. 13 shows the total output power for transmission-mode OIL.

FIG. 14 shows the total output power for reflection-mode OIL.

FIG. 15 shows simulation results for OIL-VCSEL small-signal frequency normalized amplitude response with different detuning values under a strong injection ratio.

FIG. 16 shows simulation results for OIL-VCSEL small-signal frequency phase response with different detuning values under a strong injection ratio.

FIG. 17 shows simulation results for OIL-VCSEL 1 Gb/s OOK data pattern with different detuning values under a fixed injection ratio.

FIG. 18 shows simulation results for the RF response of the small-signal analysis at 1 GHz on a locking map.

FIG. 19 shows simulation results for the extinction ratio rₑ of the 1 Gb/s OOK large-signal modulation on the same locking map as FIG. 18

FIG. 20 shows the RF response of the small-signal modulation of the OIL-VCSEL for different detuning values, at a fixed injection ratio of 20 dB.

FIG. 21 shows data pattern of the 1 Gb/s OOK large-signal modulation of OIL-VCSEL for different detuning values, at a fixed injection ratio of 12.9 dB.

FIG. 22 shows RF response of the small-signal modulation at 1 GHz of the 1 Gb/s OOK large-signal modulation on a locking map.

FIG. 23 shows extinction ratio rₑ of the 1 Gb/s OOK large-signal modulation on the same locking map as FIG. 22.

FIG. 24 shows extinction ratio rₑ of the 1 Gb/s OOK large-signal modulation on the same locking map as FIG. 23 but with lower VCSEL top facet reflectivity.

### DETAILED DESCRIPTION OF THE INVENTION

### Laser Transmitter Configuration and Experimental Setup

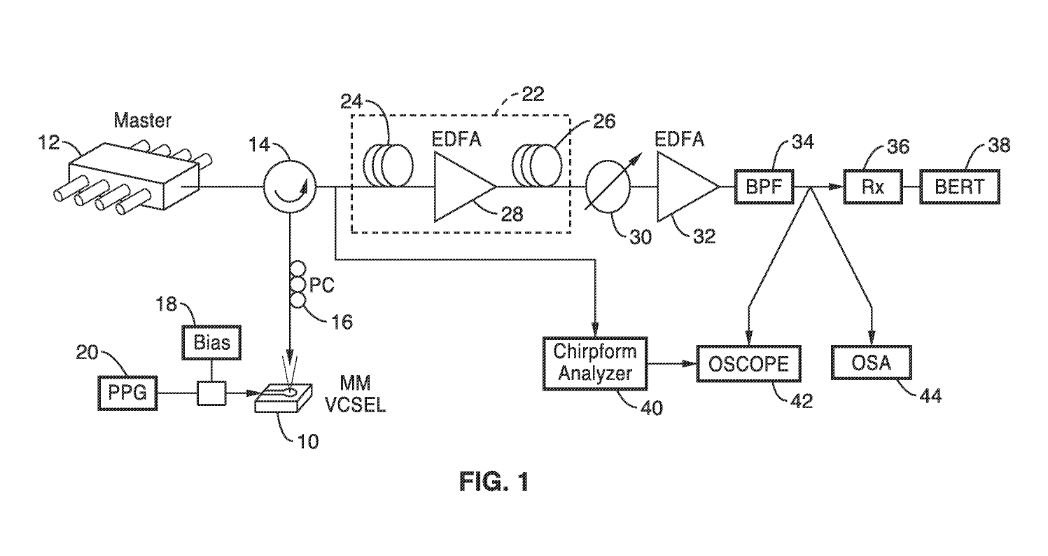

FIG. 1 shows an embodiment of our inventive optical injection locking (OIL) multi-mode (MM) vertical cavity surface emitting laser (VCSEL) transmitter with tunable chirp for dispersion compensation, in the context of an experimental setup that was used to evaluate its functionality. A chirp-form analyzer was used to investigate the reduction of the frequency chirp. Multiple spools of fiber were used to study the effect of the chromatic dispersion compensation.

In the configuration shown in FIG. 1, a MM buried tunnel junction long wavelength (BTJ-LW) VCSEL optimized for high-speed design was used as a slave laser 10. The epitaxy and processing was optimized to be impedance matched to the modulation drive voltage (50 ohm). This was done by the commercial manufacturer of the VCSEL.

A commercial off-the-shelf single mode (SM) distributed feedback (DFB) laser was coupled to the VCSEL as a master laser 12. Optionally, for unidirectional locking, an optical circulator 14 was placed between the master laser 12 and the MM VCSEL 10. As an alternative, for example, a beam splitter could be used. A polarization controller (PC) 16 was placed between the MM VCSEL 10 and the optical circulator 14.

VCSEL bias 18 and pulse pattern generator (PPG) data driving voltage 20 were “optimized” for direct modulation at 10-Gb/s. More specifically, they were “optimized” to produce the largest extinction ratio, Power of “1” level/Power of “0” level, for both the normal data pattern and inverted data pattern states.

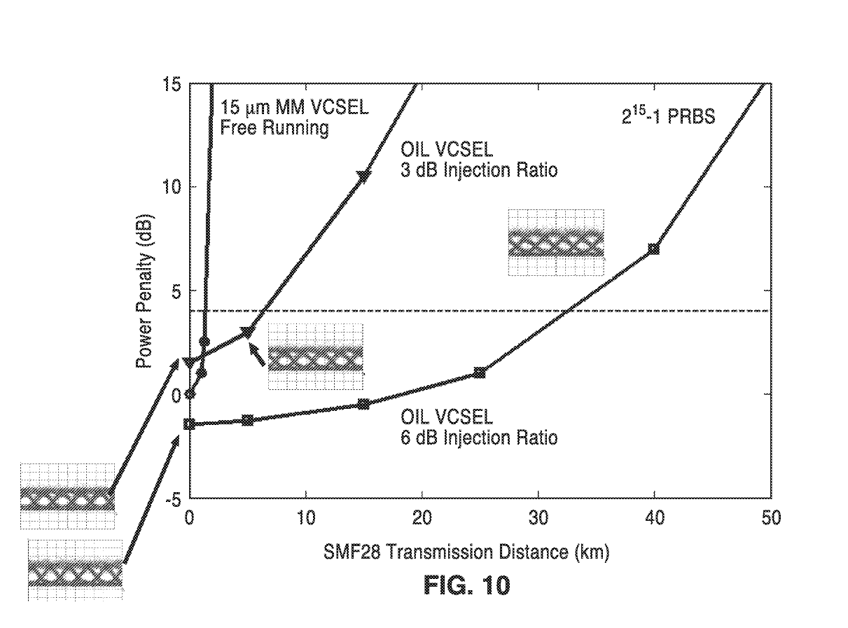

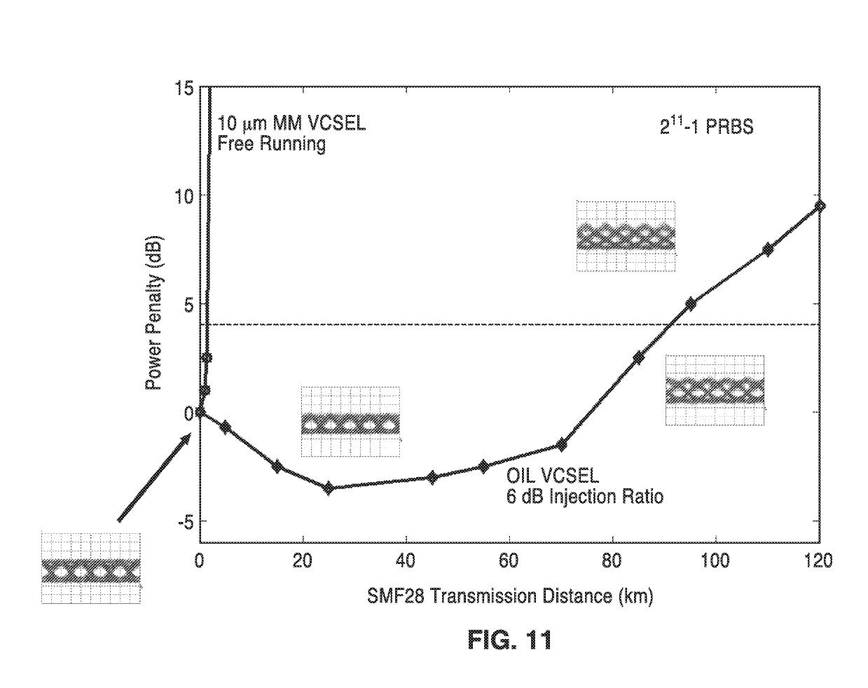

The chromatic dispersion emulator 22 was assembled from variable lengths of standard single-mode fiber (SSMF) spools 24, 26 with an erbium-doped fiber amplifier (EDFA) 28 in between to compensate for loss. The variable lengths can be extracted from FIG. 10 and FIG. 11. In this configuration, the spans used were multiple 5 km, 10 km, and 20 km spans, mixed and matched with the EDFAs to create the various lengths.

A variable optical attenuator 30 followed by an EDFA 32 and a bandpass filter (BPF) 34 were used downstream of the dispersion emulator 22. Back-to-back and fiber transmission bit error rate (BER) measurements were performed with a pre-amplified receiver (Rx) 36 and serial bit error rate tester (BERT) 38. An Advantest Q7606B chirp-form analyzer 40 was used in conjunction with a sampling oscilloscope 42 and an optical spectrum analyzer (OSA) 44 to obtain time-resolved chirp waveforms and intensity waveforms at various injection ratios.

From the foregoing description it will be appreciated that the apparatus of the present invention pertains to the transmitter portion of the above-described configuration comprising the MM VCSEL, the master laser, the coupler or circulator used to inject the master laser into the MM VCSEL, and the corresponding electrical interfaces. The remaining components are used only for testing the transmitter and do not form a part of the invention. Furthermore, as described in detail below, an inventive element in that configuration comprises adjusting frequency chirp reduction by changing the injection ratio of the master laser with respect to the VCSEL.

Adjustable Chirp And Enhanced Dispersion Compensation

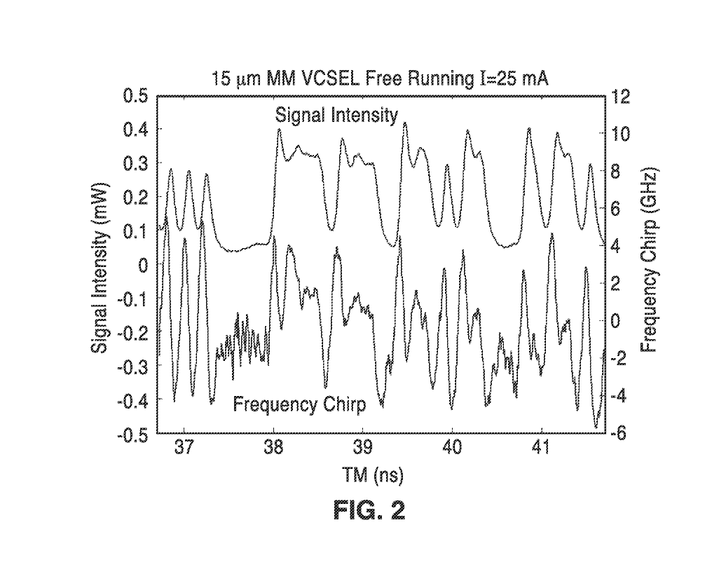

Referring now to FIG. 2 through FIG. 7, time resolved signal intensity and frequency chirp waveforms are shown for 15-μm and 10-μm MM VCSELs, where the solid lines denote signal intensity and the dashed lines denote frequency chirp.

Time-resolved intensity and chirp waveforms for a free-running 15-μm MM VCSEL biased at 25 mA and directly modulated at 10-Gb/s with 2¹⁵-1 pseudorandom binary sequence (PRBS) at 1.1 Vₚ₋ₚ are shown in FIG. 2, with solid and dashed lines, respectively. Large peak-to-peak chirp of >10 GHz peak-to-peak transient chirp and adiabatic chirp of 3 GHz are seen in the free-running case. The adiabatic chirp refers to a shift between the frequency of a sequence of continuous ON and OFF state signals. Transient chirp is the spikes at the rising and falling edges of the signal. For this case, a “positive chirp” is observed where there is positive frequency change on the rising edge and negative frequency change on the falling edge of the optical intensity or data pattern. Positive chirp increases pulse broadening when transmitting through SSMF with positive dispersion and, thus increases the power penalty.

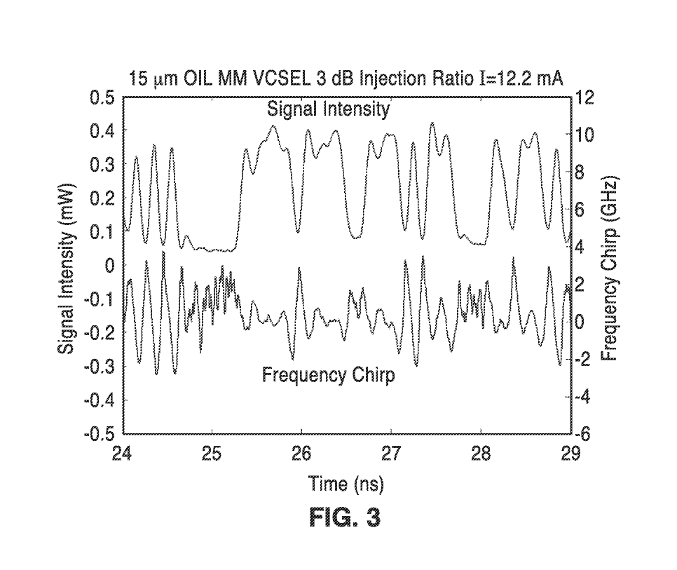

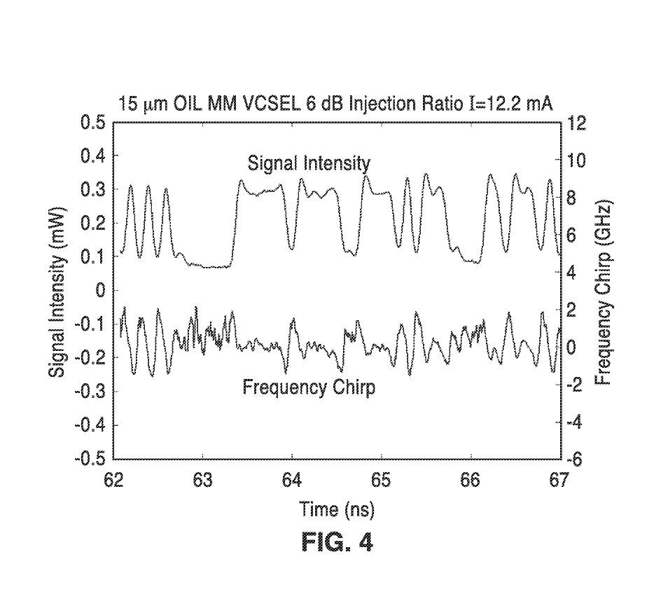

FIG. 3 and FIG. 4 show the intensity and chirp waveform when the VCSEL is injection-locked at 3 dB and 6 dB injection ratios (P_{DFB}/P_{VCSEL}), respectively. VCSEL bias is reduced to 12.2 mA to optimize injection ratio and Vₚ₋ₚ is reduced accordingly to 350 mV. Transient chirp is now the dominant chirp term with adiabatic chirp nearly totally suppressed. This phenomenon can be explained by strong injection reducing the carrier density fluctuation, which reduces the index variation and the chirp comparing to the free-running case. The adiabatic chirp for these cases is 2 GHz and 0.8 GHz. This adiabatic chirp reduction leads to higher dispersion tolerances for long monotonic sequences of bits. The transient peak-to-peak chirp values are 6.6 GHz and 3.8 GHz, respectively, with higher injection ratio showing higher suppression. Note that the transient chirp still manifests itself as positive frequency chirp.

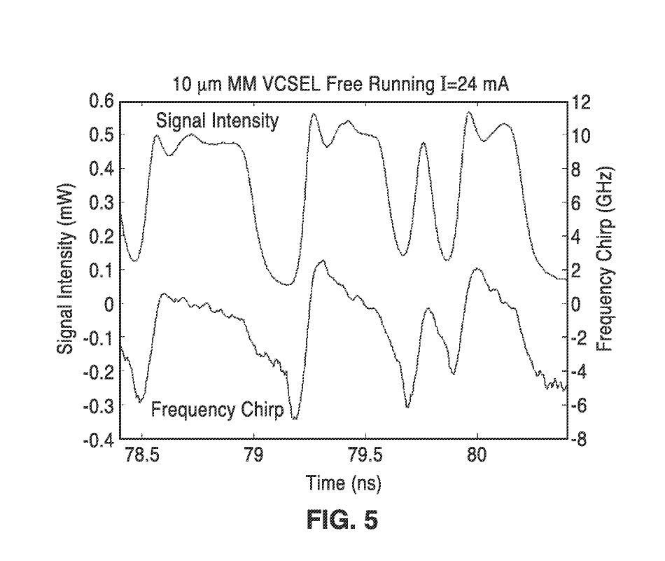

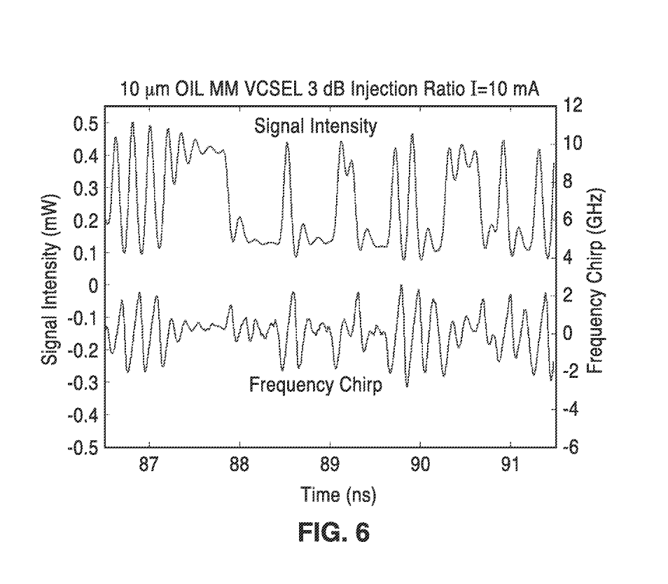

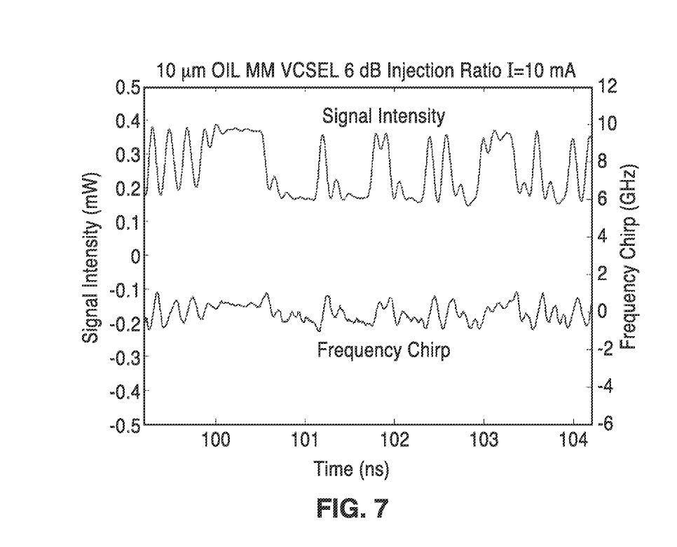

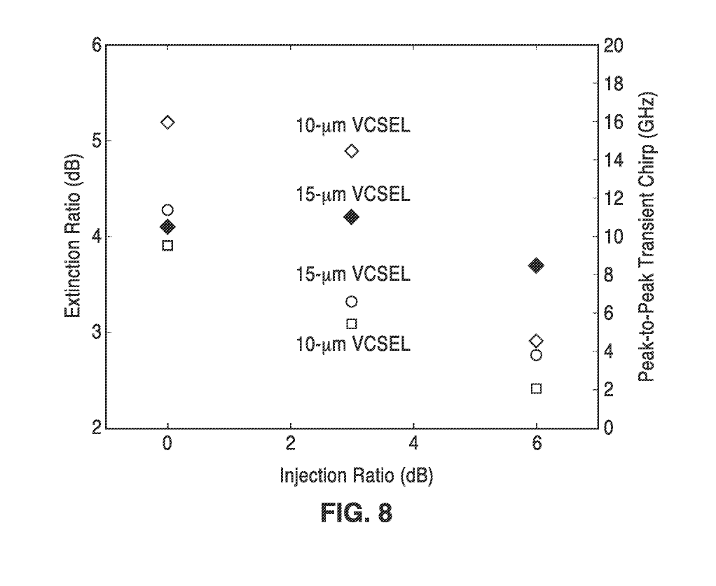

In comparison to a 15-μm MM VCSEL, a 10-μm MM VCSEL can be injection locked in the loss regime of the VCSEL and thus exhibits both chirp reduction and inversion. FIG. 5 shows intensity and chirp waveforms for a free-running 10-μm MM VCSEL biased at 24 mA and directly modulated at 10-Gb/s with 2¹¹-1 PRBS at 1.1 Vₚ₋ₚ. Similar to the 15-μm MM VCSEL, large peak-to-peak transient and adiabatic chirp of 9.5 GHz and 3 GHz, respectively. Under optical injection locking the chirp is inverted to the “negative chirp” regime where positive frequency change occurs on the falling edge and negative frequency change on the rising edge. As can be seen from FIG. 6, with a 3 dB injection ratio chirp polarity is inverted, while adiabatic and transient chirp are reduced to 2 GHz and 5.4 GHz, respectively. FIG. 7 shows that a 6 dB injection ratio suppresses the chirp further to 0.5 GHz for the adiabatic chirp and 2 GHz for the transient chirp. In FIG. 8, the extinction ratio, defined as the power ratio of average “1” and average “0”, is plotted versus injection ratio for the 10-μm and 15-μm MM VCSELs. Smaller extinction ratios are seen at higher injection ratios due to unmodulated reflected master light adding noise at the receiver. Tradeoff between extinction ratio and chirp reduction could be optimized based on the desired transmission distance.

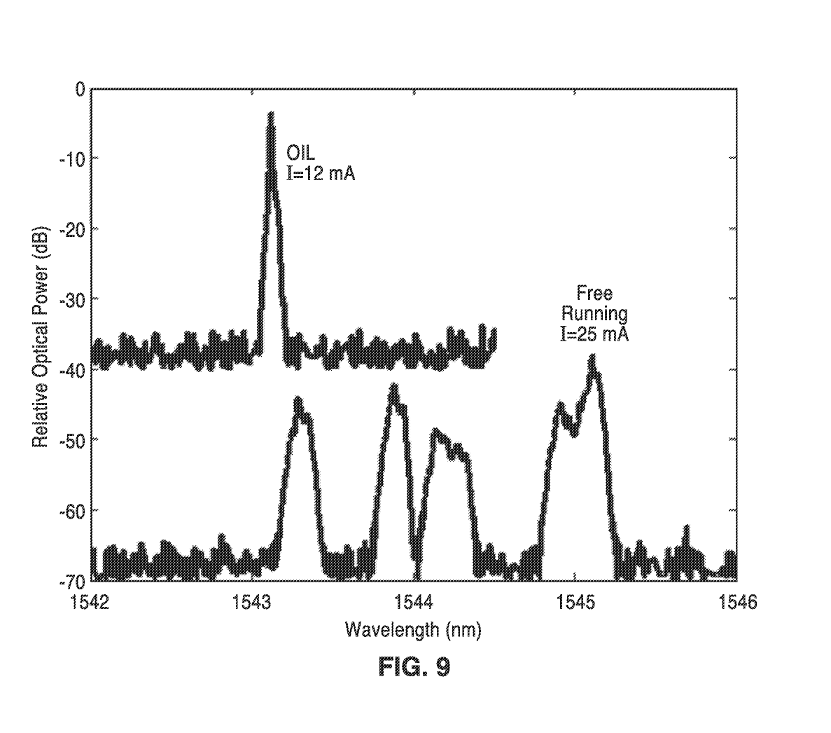

FIG. 9 shows the optical spectra of the OIL (solid line) and free-running (dashed line) 15-μm MM VCSEL. In the free-running case the fundamental, first-order and second-order modes can be seen spreading over 2.5 nm under 10 Gb/s modulation. The broad and asymmetric free-running spectrum indicates dominant adiabatic chirp and the unbalanced transient chirp. These multiple transverse modes also introduce additional transmission impairments such as mode competition noise and modal dispersion making the device ill suited for non-short reach communications. Suppression of the transverse modes by optical injection locking significantly narrows the spectrum to <0.3 nm and allows for singlemode-like transmission. In this case the MM VCSEL is locked on the fundamental mode to emulate the OIL of SM VCSELs and to maximize the injection ratio and locking range by spatially mode matching the master laser to the VCSEL.

To demonstrate the advantage of reduced frequency chirp, a chromatic dispersion tolerance study between free-running and OIL MM VCSELs was performed by transmitting 10-Gb/s signals through SSMF of variable lengths. FIG. 10 shows the power penalty versus SSMF transmission distance for a 15-μm aperture MM VCSEL free running, and OIL with 3 dB and 6 dB injection ratios. For back-to-back (O-km distance) the 3 dB injection ratio OIL case suffers a 1.5 dB power penalty compared to the free running (error-free at −21 dBm received power), while the higher 6 dB injection ratio OIL case shows a 2.5 dB power penalty improvement. The large positive adiabatic chirp of the 10-Gb/s free-running MM VCSEL limits the transmission distance to 2 km with 4 dB power penalty. With 3 dB injection the chirp reduction allows the MM VCSEL to transmit for 8 km with small power penalty. At the higher 6 dB injection, transmission distance is extended to ˜32 km, a 16× improvement over the free-running MM VCSEL. This performance is more than 2× better than that of any free-running SM VCSEL or a DFB DML previously reported.

FIG. 11 plots the power penalty versus SSMF transmission distance for the 10-μm MM VCSEL free running and with a 6 dB injection ratio with corresponding eye diagrams. The “negative chirp” observed with this OIL VCSEL causes the bits to first compress and then disperse along the fiber. Power penalty improvement compared to free running (error-free at −19 dBm) received power of up to 3 dB is seen in the region of compression, 0 to 25 km, with compression of the eyes observed due to the negative chirp. At 4 dB power penalty transmission distance is extended from 1 km to 90 km, almost a two orders of magnitude improvement.

Discussion

The frequency chirp in a directly-modulated laser (DML) arises from the intrinsic dependence of instantaneous refractive index in the laser active medium on current modulation. This leads to a frequency transient and shift in the optical pulses emitted by DMLs with increasing optical frequency at the rising edge and decreasing at the trailing edge (i.e., positive chirp). The transient and shift pull optical pulses apart when they travel in a standard single-mode fiber (SSMF), where higher frequency part of an optical pulse travel faster than the lower frequency one. Over a certain distance, the intensity of one pulse spreads over one bit period and causes detection errors. A typical approach to increase the transmission distance uses a pre-chirp scheme, with which the transmitter pulses are pre-adjusted before launched into the fiber link. This can be done by shaping the current pulses of electronic drivers or various coding techniques. However, these measures lack flexibility as they are fixed for a given modulation bandwidth and format, fiber type and distance.

Two types of chirps are present in a DML: transient—occurring at the rising and falling edges, and adiabatic—occurring at the high output level. Significant reduction of the adiabatic chirp has been achieved on OIL DMLs. However, it is the transient chirp that significantly impacts transmission distance, which has never been addressed. The transient chirp comes from the Kramers-Kronig (K-K) relationship between the real (nᵣ) and imaginary (nᵢ) part of the refractive index. As the drive current increases, nᵢ and laser output power all increase. But nᵣ decreases, which leads to an increase in laser frequency. Hence, a positive chirp is observed on the rising edge of an optical pulse. Since K-K relation is fundamental, the only possible mechanism to invert the sign of the transient chirp is to invert the dependence of the signal pattern—simply swap 1s and Os, a negative chirp can be achieved. In the following, we show that an OIL VCSEL can be conditioned to induce data inversion.

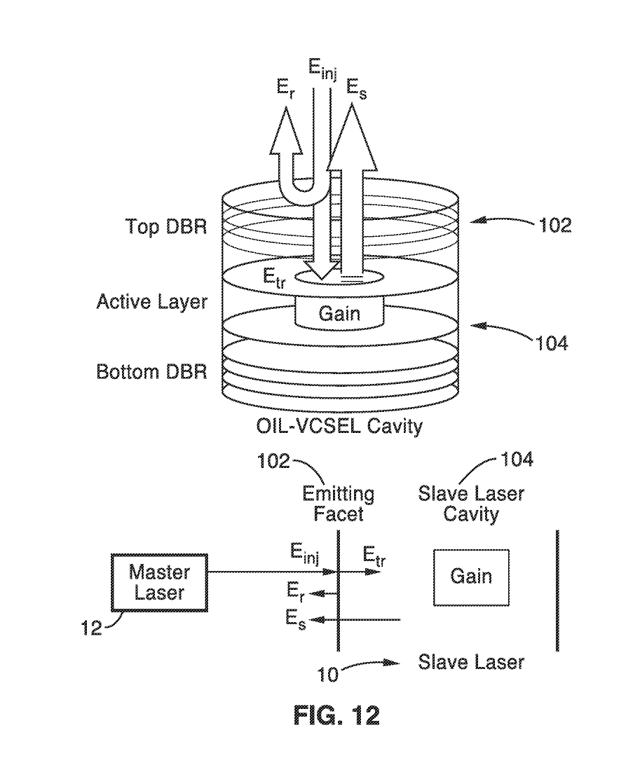

Refer now to FIG. 12 which schematically shows an OIL-VCSEL transmitter with interference effect according to one embodiment of the invention, where the total output field Eₜ=Eₛ+Eᵣ as described below. It will be appreciated that, while the following refers to a VCSEL as the slave laser, any OIL laser could be used. For example, alternatively, the slave laser could be an edge emitting laser such as a distributed feedback laser, a distributed Bragg reflector laser, or a Fabry-Perot laser.

As can be seen from FIG. 12, the master laser is configured to emit a laser field Eᵢₙⱼ that impinges onto the emitting facet 102 (e.g., a distributed Bragg reflector (DBR)) of the VCSEL slave laser 10 and is thereby divided into a transmission component Eₜᵣ=Eᵢₙⱼt and a reflection component Eᵣ=Eᵢₙⱼr. The transmission component Eₜᵣ interacts with the VCSEL cavity 104, described by the standard rate equations. A steady state is reached inside the cavity and the slave laser thereby outputs a field Eₛ that is phase coherent with Eᵢₙⱼ, with a phase shift φₛ that may range from approximately −0.5 π to approximately cot^{-1α} where α is the linewidth enhancement factor, and where φₛ is determined by the (i) detuning Δλ=λₘ−λₛ where λₘ and λₛ are the wavelength of the master laser 12 and the free running slave VCSEL 10, respectively, and (ii) injection ratio (defined as 20 log₁₀ (|Eᵢₙⱼ|/E_{fr}|)).

In the schematic shown in FIG. 12:

Eᵢₙⱼ=Eᵢₙⱼ₀ cos φₘ(t)

Eₛ=Eₛ₀ cos(φₘ(t)+φₛ)

Eᵣ=Eᵢₙⱼ₀|r|cos(φₘ(t)+φᵣ)

Eₜ=Eₛ+Eᵣ

The second and third terms represent the destructive interference that leads to the fourth term.

The laser transmitter has a total output field Eₜ that is the sum of the slave laser output light Eₛ and the reflection component Eᵣ of the master laser, where r is the reflectivity of the emitting facet 102 of the slave laser, with a phase shift φᵣ depending on r and λₘ and where φᵣ is approximately π in general. In previous models, only transmitted light was considered and, hence, the destructive interference between Eₛ and Eᵣ was ignored.

The total output power Pₜ of the steady state can be written as,

$${P}_{t} = \frac{1}{2} {\vert {E}_{t} \vert}^{2} = \frac{1}{2} {\vert {E}_{s} \vert}^{2} + \frac{1}{2} {\vert {E}_{inj} \vert}^{2} {r}^{2} + \vert {E}_{s} \cdot {E}_{inj} \vert r cos ( {φ}_{s} - {φ}_{r} )$$

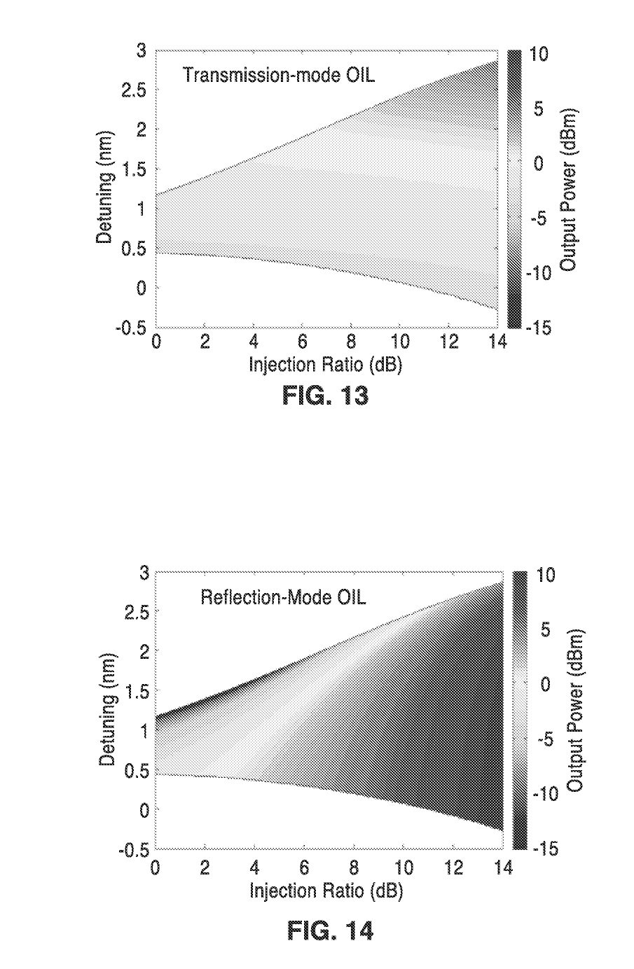

FIG. 13 shows the output power in the locking map for a transmission-mode OIL-laser, while FIG. 14 shows the output power for a reflection-mode OIL-laser where the interference effect of master laser reflection is taken into account. The total output power increases with injection ratio (defined as 20 log₁₀ (|Eᵢₙⱼ|/|E_{fr}|), where E_{fr} is the electric field of the free running slave laser light), which is the same in both cases. In the reflection-mode OIL, however, Pₜ decreases with detuning. This is because φₛ increases from approximately −0.5 π to approximately cot^{-1α}, leading to a more destructive interference and thus a lower total output power.

Small signal analysis is then performed based on the rate equations with the reflection model. Both |Eₛ|² and phase φₛ have a response under the small-signal modulation, written as Δ|Eₛ|² and Δφₛ, respectively, which are superimposed on the steady state solution. The total output power is written as,

$$\begin{matrix}{P}_{t} + Δ {P}_{t} = \frac{1}{2} {\vert {E}_{t} \vert}^{2} + \frac{1}{2} Δ {\vert {E}_{t} \vert}^{2} \\ = ( \frac{1}{2} {\vert {E}_{s} \vert}^{2} + \frac{1}{2} Δ {\vert {E}_{s} \vert}^{2} ) + \frac{1}{2} {\vert {E}_{inj} \vert}^{2} {r}^{2} + \\ \sqrt{{\vert {E}_{s} \vert}^{2} + Δ {\vert {E}_{s} \vert}^{2}} \vert {E}_{inj} \vert r cos ( {φ}_{s} + Δ {φ}_{s} - {φ}_{r} )\end{matrix}$$

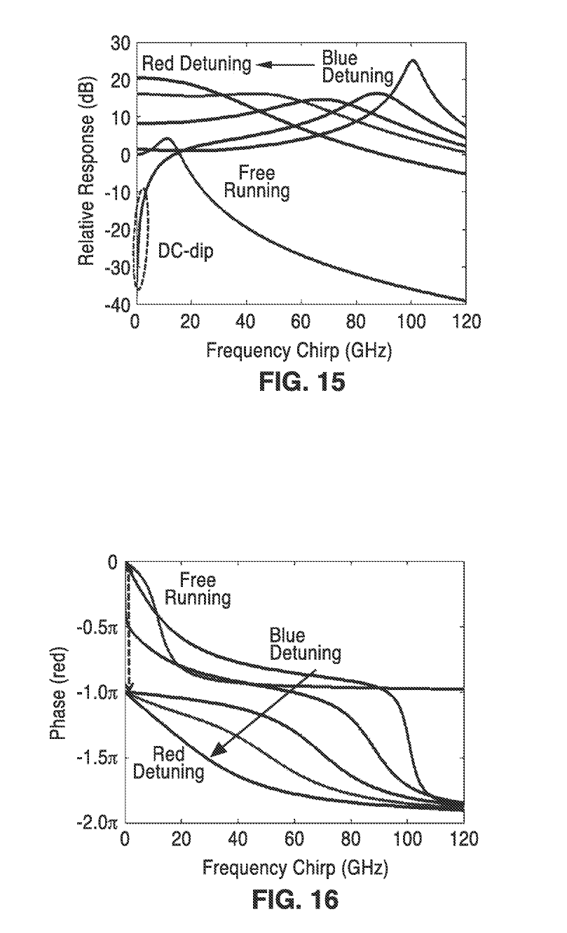

The typical frequency response of αPₜ is simulated for different detuning values under a strong injection ratio. The results are shown in FIG. 15 and FIG. 16, where the amplitude response is normalized to the free-running case. FIG. 15 shows the normalized amplitude response, and FIG. 16 shows the phase response. The arrow on FIG. 16 indicates a π phase change as the detuning increases from blue to red.

It is clearly seen that there is a DC-suppression in the amplitude response as the detuning increases from blue (Δλ<0) to red (Δλ>0). This DC-suppression corresponds to a π phase change in the phase response. It is the destructive interference between the OIL-VCSEL internal output field Eₛ and the master laser reflection light Eᵣ that leads to this DC-suppression and phase change. We will show later that this corresponds to the transition point for data pattern inversion in large signal modulation. As the detuning value increases further, the DC-dip disappears and a very large radio frequency (RF) gain is obtained, again due to the interference effect.

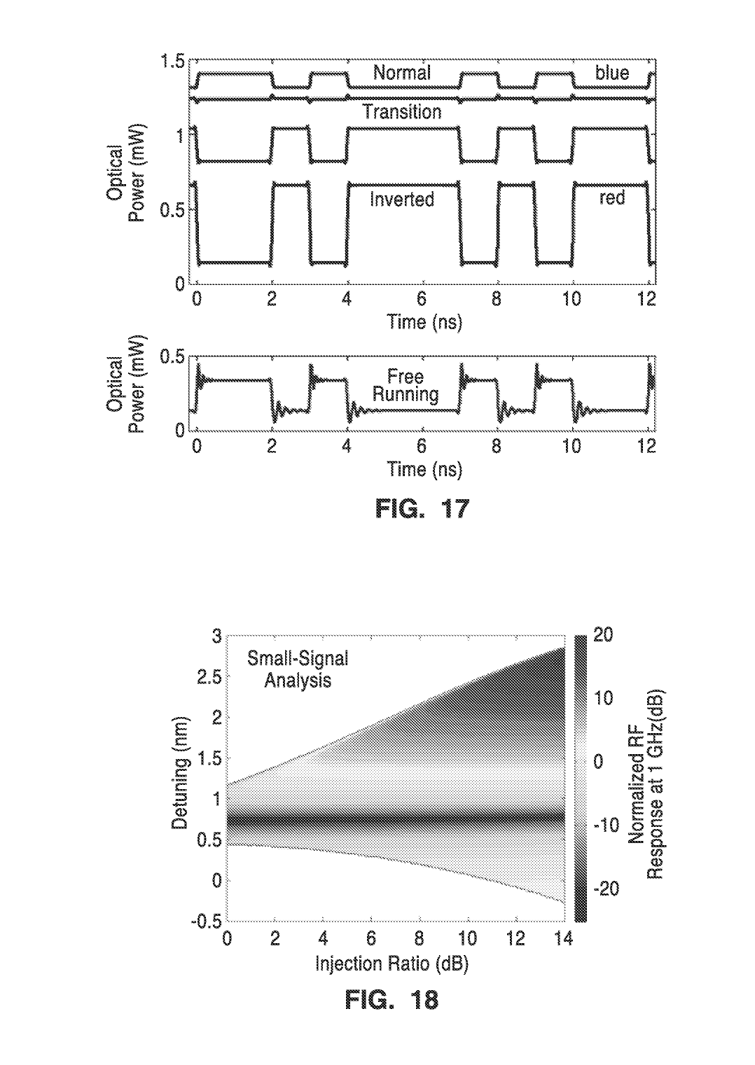

Data pattern under on-off keying (OOK) large-signal modulation is simulated by fourth-order Runge-Kutta method. Extinction ratio rₑ is defined as 10 log₁₀ (Pₜ₁/Pₜ₂), where Pₜ₁- and Pₜ₂ are the output powers corresponding to the high and low level of the modulation current. Thus a negative extinction ratio indicates data pattern inversion. FIG. 17 shows the typical 1 Gb/s data patterns for different detuning values, with a fixed injection ratio. The average total output power decreases with detuning, as predicted by FIG. 14. With increasing detuning, the data pattern changes from normal to the transition state, and then to inverted.

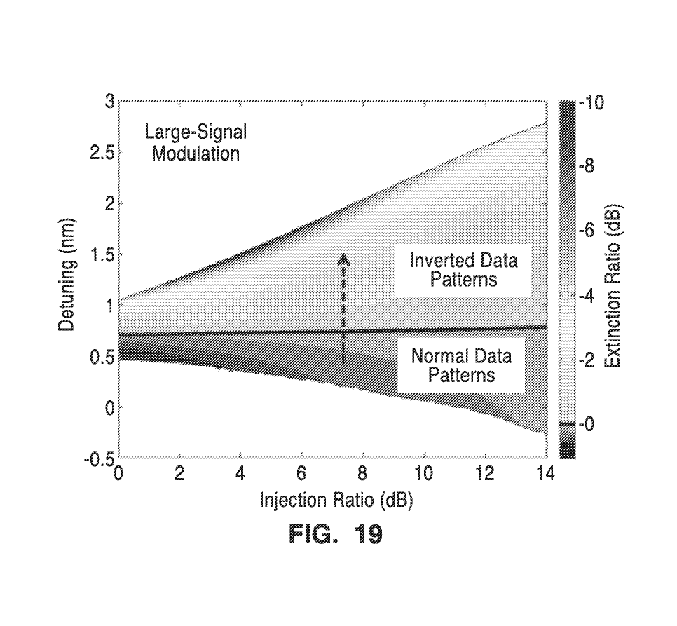

Next, we compare simulation results for small- and large-signal modulation response by sweeping the parameter space of injection ratio and detuning value. FIG. 18 and FIG. 19 show the RF response at 1 GHz and the extinction ratio rₑ of the 1 Gb/s data pattern on the same locking map. The black line on FIG. 19 indicates the conditions where rₑ=0.

The locking range of the large-signal modulation is slightly smaller than that of the small-signal modulation, due to the larger perturbation to the system in the large-signal modulation. In is interesting to note that the DC-suppression in FIG. 18 is at the same parameter space with the transition state at which the extinction ratio is zero in FIG. 19, confirming a strong correlation between them. For a certain injection ratio at the red detuning side, the interference effect makes Pₜ₁ into a very small value, resulting in a very large (in magnitude), and desirable extinction ratio with data inverted. This is indeed the regime of interests for greatly increased fiber transmission distance.

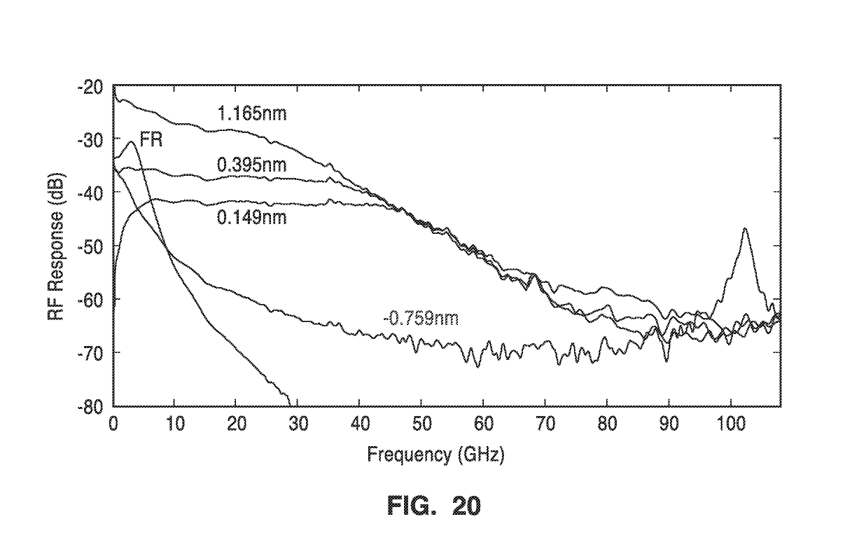

Detailed experiments on 1.55 μm VCSELs were performed to verify the simulation results and, in particular, to compare the correlation between small- and large-signal modulation. The VCSEL and experimental set up were similar to that report in “E. K. Lau, X. Zhao, H. K. Sung, D. Parekh, C. J. Chang-Hasnain, and M. G. Wu, Optics Express 16, 6609-6618 (2008).”. It was biased at 4 mA, 2.5 times threshold current, with −3 dBm free running output power. The RF response of the small-signal modulation of the OIL-VCSEL was measured at a fixed injection ratio of 20 dB for different detuning values, shown in FIG. 20. The trace “FR” denotes free running. At blue detuning (e.g., Δλ=−0.759 nm), a high resonance frequency of 100 GHz was attained with damping at lower frequencies, similar to what was reported. Increasing the detuning to 0.149 nm, a large DC-dip was seen, which was not reported before. Further detuning to the red side, the DC-dip disappeared and a large RF gain 12.5 dB at low frequency was obtained. Similar observation with >20 dB gain was reported in “L. Chrostowski, X. Zhao, and C. J. Chang-Hasnain, IEEE Trans. Microwave Theory Tech. 54, 788-796 (2006)”.

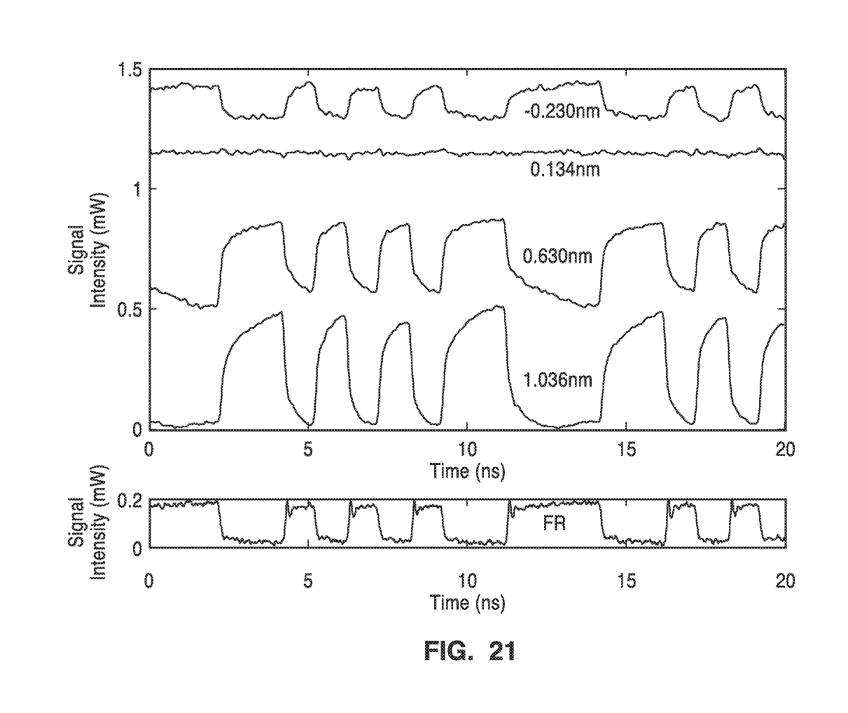

FIG. 21 shows experimental results of OIL-VCSEL under 1 Gb/s OOK large-signal modulation at different detuning values, with the injection ratio optimized at 12.9 dB for good extinction ratios. The trace “FR” denotes free running. With increasing detuning, the data pattern changes from normal, transition state, to inversion. The typical top DBR mirror field reflectivity of the VCSEL is higher than 99%, resulting in a strong reflection and interference effect of the master laser light. Extinction ratio as high as 15.6 dB with a 3.6 dB signal amplification compared to the free running case was achieved with 1.036 nm detuning.

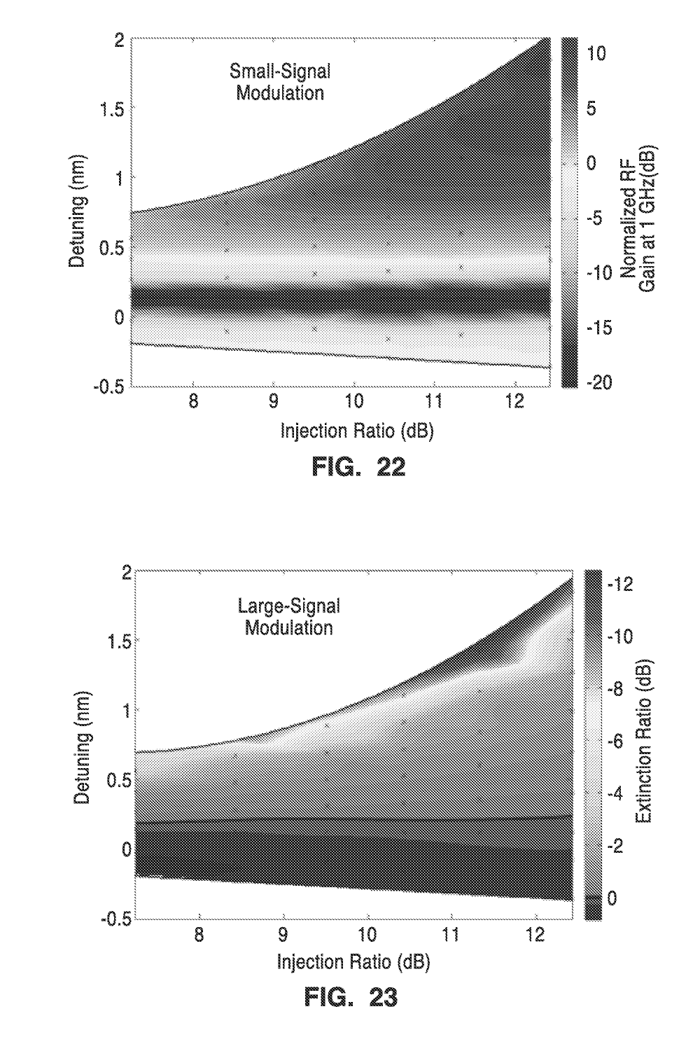

FIG. 22 and FIG. 23 show the RF response of the small-signal modulation at 1 GHz and extinction ratio re of the 1 Gb/s OOK large-signal modulation on the same locking map, respectively. The crosses show in which conditions the data were taken, and the black line on FIG. 23 indicates the rₑ=0 conditions. The RF response at 1 GHz and the extinction ratio of the 1 Gb/s data pattern were measured at different points in the same parameter space for another VCSEL (5 mA bias current which is 3 times threshold current, −0.7 dBm free running output power. The strong correlation between the DC-suppression in small-signal modulation and transition state in large-signal modulation is clearly seen. All these results agree very well with the simulation.

The reflection-mode OIL model would find its great application in optical communication and optical data processing. It predicts the conditions of data pattern inversion, which is exactly the region where the ten-fold increased single-mode fiber transmission distance was achieved in the OIL-VCSEL. Furthermore, since the OIL-VCSEL can operate either in normal data state or inverted data state, it is possible to develop some optical switching applications. For example, the master laser can be used to control switching between the two different states by changing its injection power. However, as seen in FIG. 19 and FIG. 23, the transition line is very flat with respect to the injection ratio, making this switching difficult. On the other hand, by adjusting the VCSEL's front DBR reflectivity and phase, it is possible to tilt the transition line.

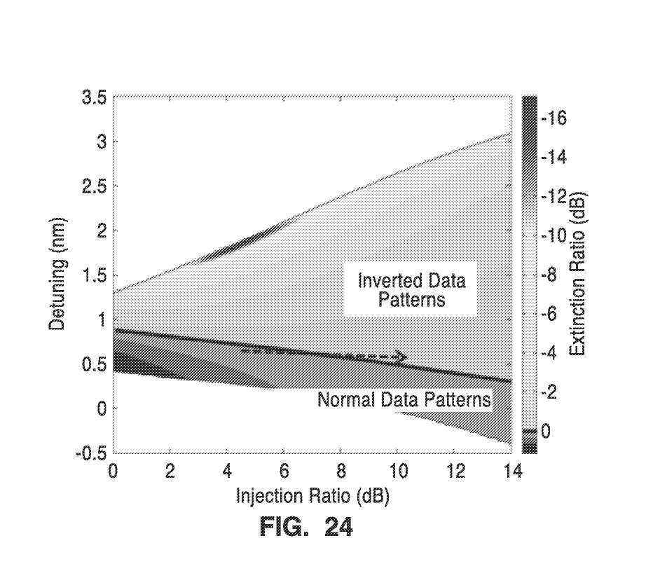

FIG. 24 shows the extinction ratio rₑ of the 1 Gb/s OOK large-signal modulation on same locking map as FIG. 23. The black line on FIG. 24 indicates the conditions where rₑ=0. The output of the VCSEL can switch between normal state and inverted state by different injection powers from the master laser. FIG. 24 shows the same simulations as FIG. 19, except that the front DBR reflectivity is changed from 0.9964 to 0.9954 while the reflection phase from 1.031 π to 0.954 π at 1550 nm. The transition line is tilted, and the output of the VCSEL can switch between normal state and inverted state by different injection power from the master laser. This may be possibly further developed into an optical logic gate.

From the foregoing description it will be appreciated that the invention can be embodied in various ways, including but not limited to the following embodiments:

1. An optical injection locking (OIL) laser transmitter, comprising: a slave laser; and a master laser; wherein said master laser is configured to emit a laser injection field Eᵢₙⱼ that impinges on said slave laser, wherein said field Eᵢₙⱼ is thereby divided into a transmission component Eₜᵣ and a reflection component Eᵣ; wherein said transmission component Eₜᵣ of said master laser interacts with said slave laser such that said slave laser reaches a locked state and outputs a field Eₛ that is phase coherent with said field Eᵢₙⱼ; and wherein said transmitter has a total output field Eₜ that is the sum of Eₛ and said reflection component Eᵣ of said master laser.

2. The laser transmitter described in embodiment 1, wherein said slave laser comprises a vertical cavity surface emitting laser.

3. The laser transmitter described in embodiment 1, wherein said slave laser comprises an edge emitting laser selected from the group of lasers consisting of distributed feedback lasers, distributed Bragg reflector lasers, and Fabry-Perot lasers.

4. The laser transmitter described in embodiment 1, wherein adjustment of injection ratio of said master laser with respect to said slave laser results in adjustment of frequency chirp reduction.

5. The laser transmitter described in embodiment 4, wherein said slave laser comprises a vertical cavity surface emitting laser.

6. The laser transmitter described in embodiment 4, wherein said slave laser comprises an edge emitting laser selected from the group of lasers consisting of distributed feedback lasers, distributed Bragg reflector lasers, and Fabry-Perot lasers.

7. The laser transmitter described in embodiment 1: wherein said slave laser is a free running laser; wherein said slave laser has a cavity; wherein said slave laser has an emitting facet; wherein said transmission component Eₜᵣ of said master laser interacts with said cavity of said slave laser such that a locked state is reached inside said cavity, wherein said slave laser thereby outputs a field Eₛ that is phase coherent with said field Eᵢₙⱼ, with a phase shift φₛ determined by the (i) detuning Δλ=λₘ−λₛ where λₘ and λₛ are wavelength of said master laser and wavelength of said slave laser, respectively, and (ii) injection ratio between the master laser and the slave laser; and wherein said transmitter has a total output field Eₜ that is the sum of Eₛ and said reflection component Eᵣ of said master laser, where r is reflectivity of said emitting facet of said slave laser, with a phase shift φᵣ that is a function of r and λₘ.

8. The laser transmitter described in embodiment 7, wherein said slave laser comprises a vertical cavity surface emitting laser.

9. The laser transmitter described in embodiment 8, wherein said emitting facet comprises a distributed Bragg reflector.

10. The laser transmitter described in embodiment 7, wherein said slave laser comprises an edge emitting laser selected from the group of lasers consisting of distributed feedback lasers, distributed Bragg reflector lasers, and Fabry-Perot lasers.

11. The laser transmitter described in embodiment 7, wherein adjustment of injection ratio of said master laser with respect to said slave laser results in adjustment of frequency chirp reduction.

12. The laser transmitter described in embodiment 11, wherein said slave laser comprises a vertical cavity surface emitting laser.

13. The laser transmitter described in embodiment 12, wherein said emitting facet comprises a distributed Bragg reflector.

14. The laser transmitter described in embodiment 11, wherein said slave laser comprises an edge emitting laser selected from the group of lasers consisting of distributed feedback lasers, distributed Bragg reflector lasers, and Fabry-Perot lasers.

15. An optical injection locking (OIL) laser transmitter, comprising: a free running slave laser, said slave laser having an emitting facet; and a master laser;

wherein said master laser is configured to emit a laser injection field Eᵢₙⱼ that impinges on said slave laser, wherein said field Eᵢₙⱼ is thereby divided into a transmission component Eₜᵣ and a reflection component Eᵣ; wherein said transmission component Eᵢₙⱼt of said master laser interacts with said cavity of said slave laser such that a locked state is reached inside said cavity, wherein said slave laser thereby outputs a field Eₛ that is phase coherent with said field Eᵢₙⱼ, with a phase shift φₛ determined by the (i) detuning Δλ=λₘ−λₛ where λₘ and λₛ are wavelength of said master laser and wavelength of said slave laser, respectively, and (ii) injection ratio between the master laser and the slave laser; and wherein said transmitter has a total output field Eₜ that is the sum of Eₛ and said reflection component Eᵣ of said master laser, where r is reflectivity of said emitting facet of said slave laser, with a phase shift λᵣ that is a function of r and λₘ.

16. The laser transmitter described in embodiment 15, wherein said slave laser comprises a vertical cavity surface emitting laser.

17. The laser transmitter described in embodiment 16, wherein said emitting facet comprises a distributed Bragg reflector.

18. The laser transmitter described in embodiment 15, wherein said slave laser comprises an edge emitting laser selected from the group of lasers consisting of distributed feedback lasers, distributed Bragg reflector lasers, and Fabry-Perot lasers.

19. The laser transmitter described in embodiment 15, wherein adjustment of injection ratio of said master laser with respect to said slave laser results in adjustment of frequency chirp reduction.

20. The laser transmitter described in embodiment 19, wherein said slave laser comprises a vertical cavity surface emitting laser.

21. The laser transmitter described in embodiment 20, wherein said emitting facet comprises a distributed Bragg reflector.

22. The laser transmitter described in embodiment 19, wherein said slave laser comprises an edge emitting laser selected from the group of lasers consisting of distributed feedback lasers, distributed Bragg reflector lasers, and Fabry-Perot lasers.

23. An optical injection locking (OIL) laser transmitter, comprising: a slave laser; and a master laser; wherein said master laser is configured to emit a laser injection field Eᵢₙⱼ that impinges on said slave laser, wherein said field Eᵢₙⱼ is thereby divided into a transmission component Eₜᵣ and a reflection component Eᵣ; wherein said transmission component Eₜᵣ of said master laser interacts with said slave laser such that said slave laser reaches a locked state and outputs a field Eₛ that is phase coherent with said field Eᵢₙⱼ; wherein said transmitter has a total output field Eₜ that is the sum of Eₛ and said reflection component Eᵣ of said master laser; and wherein adjustment of injection ratio of said master laser with respect to said slave laser results in adjustment of frequency chirp reduction.

24. The laser transmitter described in embodiment 23, wherein said slave laser comprises a vertical cavity surface emitting laser.

25. The laser transmitter described in embodiment 23, wherein said slave laser comprises an edge emitting laser selected from the group of lasers consisting of distributed feedback lasers, distributed Bragg reflector lasers, and Fabry-Perot lasers.

26. The laser transmitter described in embodiment 23: wherein said slave laser is a free running laser; wherein said slave laser has a cavity; wherein said slave laser has an emitting facet; wherein said transmission component Eₜᵣ of said master laser interacts with said cavity of said slave laser such that a locked state is reached inside said cavity, wherein said slave laser thereby outputs a field Eₛ that is phase coherent with said field Eᵢₙⱼ, with a phase shift φₛ determined by the (i) detuning Δλ=λₘ−λₛ, where λₘ and λₛ are wavelength of said master laser and wavelength of said slave laser, respectively, and (ii) injection ratio between the master laser and the slave laser; and

wherein said transmitter has a total output field Eₜ that is the sum of Eₛ and said reflection component Eᵣ of said master laser, where r is reflectivity of said emitting facet of said slave laser, with a phase shift φᵣ that is a function of r and λₘ.

27. The laser transmitter described in embodiment 26, wherein said slave laser comprises a vertical cavity surface emitting laser.

28. The laser transmitter described in embodiment 27, wherein said emitting facet comprises a distributed Bragg reflector.

29. The laser transmitter described in embodiment 23, wherein said slave laser comprises an edge emitting laser selected from the group of lasers consisting of distributed feedback lasers, distributed Bragg reflector lasers, and Fabry-Perot lasers.

30. An optical injection locking (OIL) laser transmitter, comprising: a slave laser; and a master laser; wherein adjustment of injection ratio of said master laser with respect to said slave laser results in adjustment of frequency chirp reduction.

31. The laser transmitter described in embodiment 30, wherein said slave laser comprises a vertical cavity surface emitting laser.

32. The laser transmitter described in embodiment 30, wherein said slave laser comprises an edge emitting laser selected from the group of lasers consisting of distributed feedback lasers, distributed Bragg reflector lasers, and Fabry-Perot lasers.

33. The laser transmitter described in embodiment 30: wherein said master laser is configured to emit a laser injection field Eᵢₙⱼ that impinges on said slave laser, wherein said field Eᵢₙⱼ is thereby divided into a transmission component Eₜᵣ and a reflection component Eᵣ; wherein said transmission component Eᵢₙⱼt of said master laser interacts with said slave laser such that said slave laser reaches a locked state and outputs a field Eₛ that is phase coherent with said field Eᵢₙⱼ; and wherein said transmitter has a total output field Eₜ that is the sum of Eₛ and said reflection component Eᵣ of said master laser.

34. The laser transmitter described in embodiment 33, wherein said slave laser comprises a vertical cavity surface emitting laser.

35. The laser transmitter described in embodiment 33, wherein said slave laser comprises an edge emitting laser selected from the group of lasers consisting of distributed feedback lasers, distributed Bragg reflector lasers, and Fabry-Perot lasers.

36. The laser transmitter described in embodiment 33: wherein said slave laser is a free running laser; wherein said slave laser has a cavity; wherein said slave laser has an emitting facet; wherein said transmission component Eₜᵣ of said master laser interacts with said cavity of said slave laser such that a locked state is reached inside said cavity, wherein said slave laser thereby outputs a field Eₛ that is phase coherent with said field Eᵢₙⱼ, with a phase shift φₛ determined by the (i) detuning Δλ=λₘ−λₛ, where λₘ and λₛ are wavelength of said master laser and wavelength of said slave laser, respectively, and (ii) injection ratio between the master laser and the slave laser; and wherein said transmitter has a total output field Eₜ that is the sum of Eₛ and said reflection component Eᵣ of said master laser, where r is reflectivity of said emitting facet of said slave laser, with a phase shift φᵣ that is a function of r and λₘ.

37. The laser transmitter described in embodiment 36, wherein said slave laser comprises a vertical cavity surface emitting laser.

38. The laser transmitter described in embodiment 37, wherein said emitting facet comprises a distributed Bragg reflector.

39. The laser transmitter described in embodiment 36, wherein said slave laser comprises an edge emitting laser selected from the group of lasers consisting of distributed feedback lasers, distributed Bragg reflector lasers, and Fabry-Perot lasers.

40. An optical injection locking (OIL) laser transmitter, comprising: a free running slave laser, said slave laser having a cavity and an emitting facet; and a master laser; wherein said master laser is configured to emit a laser injection field Eᵢₙⱼ that impinges on said slave laser, wherein said field Eᵢₙⱼ is thereby divided into a transmission component Eₜᵣ and a reflection component Eᵣ;

wherein said transmission component Eᵢₙⱼt of said master laser interacts with said cavity of said slave laser such that a locked state is reached inside said cavity, wherein said slave laser thereby outputs a field Eₛ that is phase coherent with said field Eᵢₙⱼ, with a phase shift φₛ determined by the (i) detuning Δλ=λₘ−λₛ, where λₘ and λₛ are wavelength of said master laser and wavelength of said slave laser, respectively, and (ii) injection ratio between the master laser and the slave laser; wherein said transmitter has a total output field Eₜ that is the sum of Eₛ and said reflection component Eᵣ of said master laser, where r is reflectivity of said emitting facet of said slave laser, with a phase shift φᵣ that is a function of r and λₘ; and wherein adjustment of injection ratio of said master laser with respect to said slave laser results in adjustment of frequency chirp reduction.

41. The laser transmitter described in embodiment 40, wherein said slave laser comprises a vertical cavity surface emitting laser.

42. The laser transmitter described in embodiment 41, wherein said emitting facet comprises a distributed Bragg reflector.

43. The laser transmitter described in embodiment 40, wherein said slave laser comprises an edge emitting laser selected from the group of lasers consisting of distributed feedback lasers, distributed Bragg reflector lasers, and Fabry-Perot lasers.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. An optical injection locking (OIL) laser transmitter, comprising:
a slave laser; and
a master laser;
wherein said master laser is configured to emit a laser injection field Eᵢₙⱼ that impinges on said slave laser, wherein said field Eᵢₙⱼ is thereby divided into a transmission component Eₜᵣ and a reflection component Eᵣ;
wherein said transmission component Eₜᵣ of said master laser interacts with said slave laser such that said slave laser reaches a locked state and outputs a field Eₛ that is phase coherent with said field Eᵢₙⱼ; and
wherein said transmitter has a total output field Eₜ that is the sum of Eₛ and said reflection component Eᵣ of said master laser.

2. The laser transmitter of claim 1, wherein said slave laser comprises a vertical cavity surface emitting laser.

3. The laser transmitter of claim 1, wherein said slave laser comprises an edge emitting laser selected from the group of lasers consisting of distributed feedback lasers, distributed Bragg reflector lasers, and Fabry-Perot lasers.

4. The laser transmitter of claim 1, wherein adjustment of injection ratio of said master laser with respect to said slave laser results in adjustment of frequency chirp reduction.

5. The laser transmitter of claim 4, wherein said slave laser comprises a vertical cavity surface emitting laser.

6. The laser transmitter of claim 4, wherein said slave laser comprises an edge emitting laser selected from the group of lasers consisting of distributed feedback lasers, distributed Bragg reflector lasers, and Fabry-Perot lasers.

7. The laser transmitter of claim 1:
wherein said slave laser is a free running laser;
wherein said slave laser has a cavity;
wherein said slave laser has an emitting facet;
wherein said transmission component Eₜᵣ of said master laser interacts with said cavity of said slave laser such that a locked state is reached inside said cavity, wherein said slave laser thereby outputs a field Eₛ that is phase coherent with said field Eᵢₙⱼ, with a phase shift φₛ determined by the (i) detuning Δλ=λₘ−λₛ where λₘ and λₛ are wavelength of said master laser and wavelength of said slave laser, respectively, and (ii) injection ratio between the master laser and the slave laser; and
wherein said transmitter has a total output field Eₜ that is the sum of Eₛ and said reflection component Eᵣ of said master laser, where r is reflectivity of said emitting facet of said slave laser, with a phase shift φᵣ that is a function of r and λₘ.

8. The laser transmitter of claim 7, wherein said slave laser comprises a vertical cavity surface emitting laser.

9. The laser transmitter of claim 8, wherein said emitting facet comprises a distributed Bragg reflector.

10. The laser transmitter of claim 7, wherein said slave laser comprises an edge emitting laser selected from the group of lasers consisting of distributed feedback lasers, distributed Bragg reflector lasers, and Fabry-Perot lasers.

11. The laser transmitter of claim 7, wherein adjustment of injection ratio of said master laser with respect to said slave laser results in adjustment of frequency chirp reduction.

12. The laser transmitter of claim 11, wherein said slave laser comprises a vertical cavity surface emitting laser.

13. The laser transmitter of claim 12, wherein said emitting facet comprises a distributed Bragg reflector.

14. The laser transmitter of claim 11, wherein said slave laser comprises an edge emitting laser selected from the group of lasers consisting of distributed feedback lasers, distributed Bragg reflector lasers, and Fabry-Perot lasers.

15. An optical injection locking (OIL) laser transmitter, comprising:
a free running slave laser, said slave laser having an emitting facet; and
a master laser;
wherein said master laser is configured to emit a laser injection field Eᵢₙⱼ that impinges on said slave laser, wherein said field Eᵢₙⱼ is thereby divided into a transmission component Eₜᵣ and a reflection component Eᵣ;
wherein said transmission component Eᵢₙⱼt of said master laser interacts with said cavity of said slave laser such that a locked state is reached inside said cavity, wherein said slave laser thereby outputs a field Eₛ that is phase coherent with said field Eᵢₙⱼ, with a phase shift φₛ determined by the (i) detuning Δλ=λₘ−λₛ where λₘ and λₛ are wavelength of said master laser and wavelength of said slave laser, respectively, and (ii) injection ratio between the master laser and the slave laser; and
wherein said transmitter has a total output field Eₜ that is the sum of Eₛ and said reflection component Eᵣ of said master laser, where r is reflectivity of said emitting facet of said slave laser, with a phase shift φᵣ that is a function of r and λₘ.

16. The laser transmitter of claim 15, wherein said slave laser comprises a vertical cavity surface emitting laser.

17. The laser transmitter of claim 16, wherein said emitting facet comprises a distributed Bragg reflector.

18. The laser transmitter of claim 15, wherein said slave laser comprises an edge emitting laser selected from the group of lasers consisting of distributed feedback lasers, distributed Bragg reflector lasers, and Fabry-Perot lasers.

19. The laser transmitter of claim 15, wherein adjustment of injection ratio of said master laser with respect to said slave laser results in adjustment of frequency chirp reduction.

20. The laser transmitter of claim 19, wherein said slave laser comprises a vertical cavity surface emitting laser.

21. The laser transmitter of claim 20, wherein said emitting facet comprises a distributed Bragg reflector.

22. The laser transmitter of claim 19, wherein said slave laser comprises an edge emitting laser selected from the group of lasers consisting of distributed feedback lasers, distributed Bragg reflector lasers, and Fabry-Perot lasers.

23. An optical injection locking (OIL) laser transmitter, comprising:
a slave laser; and
a master laser;
wherein said master laser is configured to emit a laser injection field Eᵢₙⱼ that impinges on said slave laser, wherein said field Eᵢₙⱼ is thereby divided into a transmission component Eₜᵣ and a reflection component Eᵣ;
wherein said transmission component Eₜᵣ of said master laser interacts with said slave laser such that said slave laser reaches a locked state and outputs a field Eₛ that is phase coherent with said field Eᵢₙⱼ;
wherein said transmitter has a total output field Eₜ that is the sum of Eₛ and said reflection component Eᵣ of said master laser; and
wherein adjustment of injection ratio of said master laser with respect to said slave laser results in adjustment of frequency chirp reduction.

24. The laser transmitter of claim 23, wherein said slave laser comprises a vertical cavity surface emitting laser.

25. The laser transmitter of claim 23, wherein said slave laser comprises an edge emitting laser selected from the group of lasers consisting of distributed feedback lasers, distributed Bragg reflector lasers, and Fabry-Perot lasers.

26. The laser transmitter of claim 23:
wherein said slave laser is a free running laser;
wherein said slave laser has a cavity;
wherein said slave laser has an emitting facet;
wherein said transmission component Eₜᵣ of said master laser interacts with said cavity of said slave laser such that a locked state is reached inside said cavity, wherein said slave laser thereby outputs a field Eₛ that is phase coherent with said field Eᵢₙⱼ, with a phase shift φₛ determined by the (i) detuning Δλ=λₘ−λₛ, where λₘ and λₛ are wavelength of said master laser and wavelength of said slave laser, respectively, and (ii) injection ratio between the master laser and the slave laser; and
wherein said transmitter has a total output field Eₜ that is the sum of Eₛ and said reflection component Eᵣ of said master laser, where r is reflectivity of said emitting facet of said slave laser, with a phase shift φᵣ that is a function of r and λₘ.

27. The laser transmitter of claim 26, wherein said slave laser comprises a vertical cavity surface emitting laser.

28. The laser transmitter of claim 27, wherein said emitting facet comprises a distributed Bragg reflector.

29. The laser transmitter of claim 23, wherein said slave laser comprises an edge emitting laser selected from the group of lasers consisting of distributed feedback lasers, distributed Bragg reflector lasers, and Fabry-Perot lasers.

30. An optical injection locking (OIL) laser transmitter, comprising:
a slave laser; and
a master laser;
wherein adjustment of injection ratio of said master laser with respect to said slave laser results in adjustment of frequency chirp reduction.

31. The laser transmitter of claim 30, wherein said slave laser comprises a vertical cavity surface emitting laser.

32. The laser transmitter of claim 30, wherein said slave laser comprises an edge emitting laser selected from the group of lasers consisting of distributed feedback lasers, distributed Bragg reflector lasers, and Fabry-Perot lasers.

33. The laser transmitter of claim 30:
wherein said master laser is configured to emit a laser injection field Eᵢₙⱼ that impinges on said slave laser, wherein said field Eᵢₙⱼ is thereby divided into a transmission component Eₜᵣ and a reflection component Eᵣ;
wherein said transmission component Eᵢₙⱼt of said master laser interacts with said slave laser such that said slave laser reaches a locked state and outputs a field Eₛ that is phase coherent with said field Eᵢₙⱼ; and
wherein said transmitter has a total output field Eₜ that is the sum of Eₛ and said reflection component Eᵣ of said master laser.

34. The laser transmitter of claim 33, wherein said slave laser comprises a vertical cavity surface emitting laser.

35. The laser transmitter of claim 33, wherein said slave laser comprises an edge emitting laser selected from the group of lasers consisting of distributed feedback lasers, distributed Bragg reflector lasers, and Fabry-Perot lasers.

36. The laser transmitter of claim 33:
wherein said slave laser is a free running laser;
wherein said slave laser has a cavity;
wherein said slave laser has an emitting facet;
wherein said transmission component Eₜᵣ of said master laser interacts with said cavity of said slave laser such that a locked state is reached inside said cavity, wherein said slave laser thereby outputs a field Eₛ that is phase coherent with said field Eᵢₙⱼ, with a phase shift φₛ determined by the (i) detuning Δλ=λₘ−λₛ, where λₘ and λₛ are wavelength of said master laser and wavelength of said slave laser, respectively, and (ii) injection ratio between the master laser and the slave laser; and
wherein said transmitter has a total output field Eₜ that is the sum of Eₛ and said reflection component Eᵣ of said master laser, where r is reflectivity of said emitting facet of said slave laser, with a phase shift φᵣ that is a function of r and λₘ.

37. The laser transmitter of claim 36, wherein said slave laser comprises a vertical cavity surface emitting laser.

38. The laser transmitter of claim 37, wherein said emitting facet comprises a distributed Bragg reflector.

39. The laser transmitter of claim 36, wherein said slave laser comprises an edge emitting laser selected from the group of lasers consisting of distributed feedback lasers, distributed Bragg reflector lasers, and Fabry-Perot lasers.

40. An optical injection locking (OIL) laser transmitter, comprising:
a free running slave laser, said slave laser having a cavity and an emitting facet; and
a master laser;
wherein said master laser is configured to emit a laser injection field Eᵢₙⱼ that impinges on said slave laser, wherein said field Eᵢₙⱼ is thereby divided into a transmission component Eₜᵣ and a reflection component Eᵣ;
wherein said transmission component Eᵢₙⱼt of said master laser interacts with said cavity of said slave laser such that a locked state is reached inside said cavity, wherein said slave laser thereby outputs a field Eₛ that is phase coherent with said field Eᵢₙⱼ, with a phase shift φₛ determined by the (i) detuning Δλ=λₘ−λₛ, where λₘ and λₛ are wavelength of said master laser and wavelength of said slave laser, respectively, and (ii) injection ratio between the master laser and the slave laser;
wherein said transmitter has a total output field Eₜ that is the sum of Eₛ and said reflection component Eᵣ of said master laser, where r is reflectivity of said emitting facet of said slave laser, with a phase shift φᵣ that is a function of r and λₘ; and
wherein adjustment of injection ratio of said master laser with respect to said slave laser results in adjustment of frequency chirp reduction.

41. The laser transmitter of claim 40, wherein said slave laser comprises a vertical cavity surface emitting laser.

42. The laser transmitter of claim 41, wherein said emitting facet comprises a distributed Bragg reflector.

43. The laser transmitter of claim 40, wherein said slave laser comprises an edge emitting laser selected from the group of lasers consisting of distributed feedback lasers, distributed Bragg reflector lasers, and Fabry-Perot lasers.
